(19) United States
(12) Patent Application Publication
(10) Pub. No.: US 2012/0151246 A1
(43) Pub. Date: Jun. 14, 2012

(54) COMMUNICATION INTERFACE APPARATUS, TRANSMISSION CONTROL METHOD, AND CONNECTION SHUTDOWN CONTROL METHOD

(75) Inventor: Masaru TANAKA, Kawasaki (JP)

(73) Assignee: FUJITSU LIMITED, Kawasaki (JP)

(21) Appl. No.: 13/306,670

(22) Filed: Nov. 29, 2011

(30) Foreign Application Priority Data
Dec. 9, 2010 (JP) 2010-274365

(51) Int. Cl. G06F 11/14

(52) U.S. Cl. 714/4.1; 714/E11.142

(57) ABSTRACT

A communication interface apparatus 10 includes: a transmitter/receiver 50 which transmits and receives a client signal to and from a client apparatus 2; a detector 51 which detects a failure in reception of the client signal; an indication signal transmitter 61 which transmits, to a transmission apparatus 4b at a far end of a path set up over a transmission network 3 to transmit the client signal, an indication signal that causes the transmission apparatus to shut down a connection for transmitting and receiving the client signal to and from a client apparatus 2b; and an indication signal controller 71 which controls to not transmit out the indication signal unless the failure in reception of the client signal continues over a first waiting time.

### CROSS-REFERENCE TO RELATED APPLICATIONS

This application is based upon and claims the benefit of priority of the prior Japanese Patent Application No. 2010-274365, filed on Dec. 9, 2010, the entire contents of which are incorporated herein by reference.

### FIELD

The embodiments discussed herein are related to techniques for indicating a failure of connection with a client apparatus in a transmission apparatus that transmits a client signal over a transmission network.

### BACKGROUND

In a transmission network in which a client signal is transmitted by relaying it from one transmission apparatus to another, if a transmission apparatus at one end of a path set up between it and another transmission apparatus detects a failure, the transmission apparatus notifies that other transmission apparatus of the occurrence of the failure. The transmission apparatus notified of the occurrence of the failure shuts down the connection with a client apparatus. This prevents data from flowing uselessly.

One example of an indication signal used to indicate the occurrence of a failure is a CSF (Client Signal Fail) indication which is defined, for example, in ITU-T (International Telecommunication Union Telecommunication Standardization Sector) G7041, etc. Failure indication and shutdown control using such an indication signal is called the “link-down indication transfer function.”

FIG. 1 is a diagram illustrating the link-down indication transfer function using the CSF. In the communication system depicted in FIG. 1, transmission apparatuses 91a and 91b transmit over a transmission network a client signal to be transferred between client apparatuses 90a and 90b.

(1) If a failure occurs on the connection between the transmission apparatus 91a and the client apparatus 90a, the transmission apparatus 91a detects a LoS (Loss of Signal) indicating the loss of signal from the client apparatus 90a.

(2) Thereupon, the transmission apparatus 91a transmits a CSF to the transmission apparatus 91b at the opposite end.

(3) The transmission apparatus 91b that received the CSF performs shutdown control to shut down the connection with the client apparatus 90b.

(4) As a result, the client apparatus 90b detects a LoS indicating the loss of signal from the transmission apparatus 91b. Upon detecting the LoS, the client apparatus 90b performs link-down control on the connection with the transmission apparatus 91b.

(5) The transmission apparatus 91b detects a LoS indicating the loss of signal from the client apparatus 90b. However, the transmission apparatus 91b is currently receiving the incoming CSF; therefore, by determining that the detected LoS is the LoS that occurred due to the reception of the CSF, the transmission apparatus 91b holds off transmitting a CSF to the transmission apparatus 91a.

(6) After that, the failed connection between the transmission apparatus 91a and the client apparatus 90a is restored.

(7) When the transmission apparatus 91a detects the reception of an incoming signal from the client apparatus 90a, the transmission apparatus 91a stops transmitting the CSF.

(8) When the incoming CSF stops, the transmission apparatus 91b clears the shutdown condition of the connection with the client apparatus 90b.

(9) At this time, a situation in which the transmission apparatus 91b is no longer receiving the CSF but the loss of signal from the client apparatus 90b is still continuing occurs. As a result, the transmission apparatus 91b transmits a CSF to the transmission apparatus 91a.

(10) The transmission apparatus 91a receives the CSF.

(11) When the client apparatus 90b detects the reception of a signal from the transmission apparatus 91b, the client apparatus 90b performs link-up control on the connection with the transmission apparatus 91b.

(12) When the transmission apparatus 91b detects the link-up of the connection with the client apparatus 90b, the transmission apparatus 91b stops transmitting the CSF.

(13) The reception of the CSF at the transmission apparatus 91b stops.

In the prior art, for use in a communication control apparatus between transmission control apparatuses, a method for setting a system parameter by an automatic delay measurement has been proposed. In this method, an exchange apparatus starts a delay measuring timer by sending a delay measuring frame. Upon receiving the delay measuring frame, a terminal apparatus returns a delay measurement response frame to the exchange apparatus.

When the delay measurement response frame is received, the exchange apparatus stops the delay measuring timer, and a line delay is obtained from the timer value, the line speed, and the number of bits in the delay measurement/response frame. Then, from the obtained delay, the number of bits for a maximum frame length, and the number of buffers contained in the apparatus, the exchange apparatus obtains a maximum value K of the number of outstanding information frames so that it does not exceeds the modulo-1 value. Next, a response transmission waiting timer value T2 is obtained from the maximum value K of the number of outstanding information frames, the line delay, and the transmission time per frame, and then a frame response waiting timer value T1 is obtained from the response transmission waiting timer value T2, the line delay, and the transmission time per frame.

Related art is disclosed in Japanese Laid-open Patent Publications No. 2003-273939 and No. 1-168141.

### SUMMARY

A communication interface apparatus according to one embodiment includes: a transmitter/receiver which transmits and receives a client signal to and from a client apparatus; a detector which detects a failure in reception of the client signal; an indication signal transmitter which transmits, to a transmission apparatus at a far end of a path set up over a transmission network to transmit the client signal, an indication signal that causes the transmission apparatus to shut down a connection for transmitting and receiving the client signal to and from a client apparatus; and an indication signal controller which performs control not to transmit out the indication signal unless the failure in reception of the client signal continues over a first waiting time.

A communication interface apparatus according to another embodiment includes: a transmitter/receiver which transmits and receives a client signal to and from a client apparatus; an indication signal transmitter which transmits, to a transmission apparatus at a far end of a path set up over a transmission network to transmit the client signal via the transmission network, an indication signal that causes the transmission apparatus to shut down a connection for transmitting and receiving the client signal to and from a client apparatus; an indication signal detector which detects the indication signal transmitted from the transmission apparatus; a connection shutdown circuit which shuts down the connection that the transmitter/receiver uses for transmission and reception of the client signal; a connection shutdown controller which performs control so that the connection shutdown circuit does not shut down the connection unless the indication signal is detected continuously over a second waiting time; and a second measuring circuit which measures a time interval that elapses from the time that the transmission of the indication signal by the indication signal transmitter is stopped until the time that the indication signal becomes no longer detected by the indication signal detection circuit. The second waiting time is the time interval measured by the second measuring circuit.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a link-down indication transfer function.

FIG. 2 is a diagram illustrating in simplified form an example of the configuration of a communication system.

FIG. 3 is a diagram illustrating in simplified form an example of the configuration of a transmission apparatus.

FIG. 4 is a diagram illustrating an example of the hardware configuration of a control unit depicted in FIG. 3.

FIG. 5 is a diagram illustrating an example of the hardware configuration of a client signal line interface unit.

FIG. 6 is a diagram illustrating a configuration example of the control unit depicted in FIG. 4.

FIG. 7 is a diagram illustrating a configuration example of a signal processing unit depicted in FIG. 5.

FIG. 8 is a diagram illustrating a configuration example of a first framer depicted in FIG. 5.

FIG. 9 is a diagram illustrating a configuration example of a LIU control unit depicted in FIG. 5.

FIG. 10 is a diagram illustrating an indication signal transmitting process.

FIG. 11 is a diagram illustrating a connection shutdown process.

FIG. 12 is a diagram illustrating the process for determining a first waiting time.

FIG. 13 is a diagram illustrating the process for determining a second waiting time.

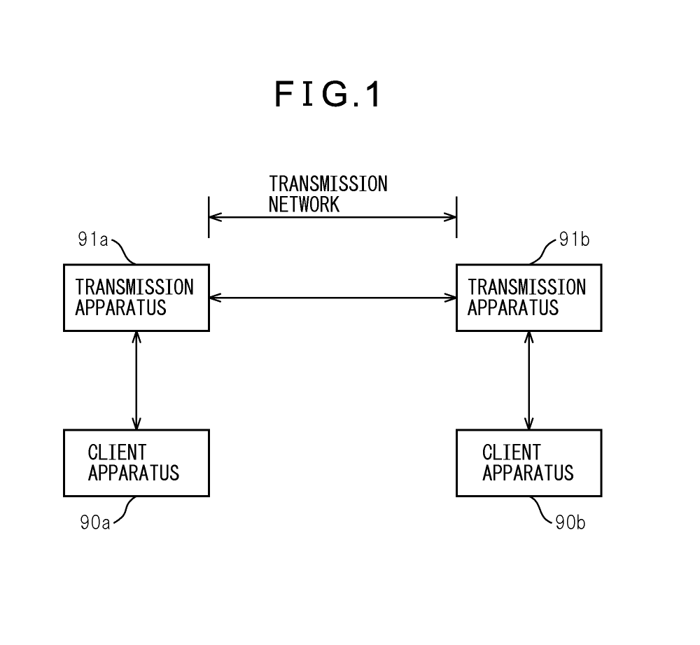

### DESCRIPTION OF EMBODIMENT(S)

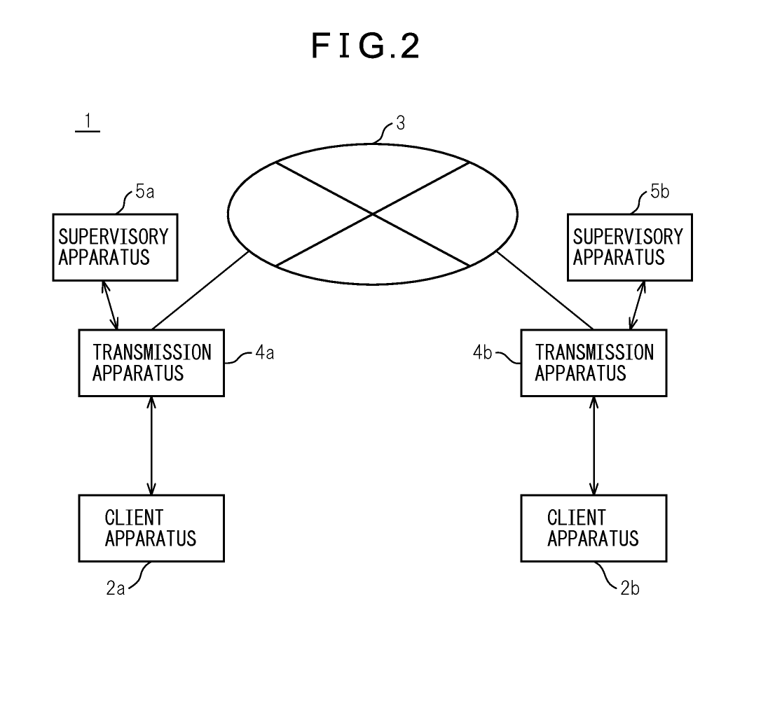

Embodiments of the present invention will be described below with reference to the accompanying drawings. FIG. 2 is a diagram illustrating in simplified form an example of the configuration of a communication system. The communication system 1 includes client apparatuses 2a and 2b, a transmission network 3, transmission apparatuses 4a and 4b, and supervisory apparatuses 5a and 5b. In the following description, the client apparatuses 2a and 2b may be collectively referred to as the “client apparatus 2”. Likewise, the transmission apparatuses 4a and 4b may be collectively referred to as the “transmission apparatus 4”. Further, the supervisory apparatuses 5a and 5b may be collectively referred to as the “supervisory apparatus 5”.

The transmission network 3 may be, for example, a synchronous transmission network such as SDH (Synchronous Digital Hierarch Y)/SONET (Synchronous Optical NETwork), or may be an asynchronous transmission network such as Ethernet (registered trademark). The transmission apparatus 4 receives a client signal from the client apparatus 2 and transmits it out onto the transmission network 3, or receives via the transmission network 3 a client signal destined for the client apparatus 2 and transfers it to the client apparatus 2. The client apparatus 2 is, for example, a packet switch or the like.

When transmitting client signals via the transmission network 3 to transfer them between the client apparatuses 2a and 2b, a path is set up over the transmission network 3 between the transmission apparatuses 4a and 4b. The supervisory apparatus 5 transmits a command to the transmission apparatus 4 for execution, or monitors the conditions of the transmission apparatus 4 and the transmission network 3.

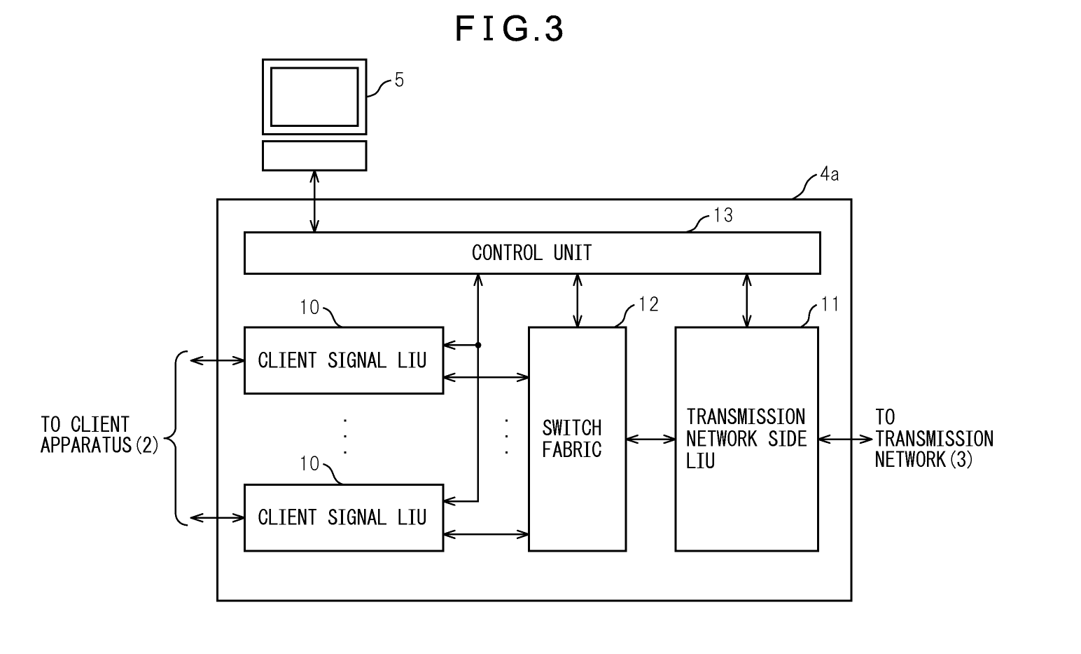

FIG. 3 is a diagram illustrating in simplified form an example of the configuration of the transmission apparatus 4a. The transmission apparatus 4a includes client signal line interface units 10, . . . 10, a transmission network side line interface unit 11, a switch fabric 12, and a control unit 13. In the description and drawings given herein, each line interface unit will be designated “LIU”.

The client signal LIU 10 encapsulates the client signal received from the client apparatus 2a into a frame for transmission on the transmission network 3. If necessary, the client signal LIU 10 further maps it into another frame used for transfer between units within the client signal line interface unit 10, and passes it to the switch fabric 12.

Further, the client signal LIU 10 decapsulates a client signal from a frame received over the transmission network 3 and transferred through the switch fabric 12. The client signal LIU 10 transmits the decapsulated client signal to the client apparatus 2a. The client signal LIU 10 is further responsible for detecting a connection or link to the client apparatus 2a, controlling connection shutdown, and detecting the reception of a signal from the client apparatus 2a.

The transmission network side LIU 11 is responsible for transmission and reception of frames over the transmission network 3. The transmission network side LIU 11 retrieves, from among the received frames, a frame that contains a client signal destined for the client apparatus 2a connected to the transmission apparatus 4a, and passes it to the switch fabric 12. Further, the transmission network side LIU 11 transmits frames received from the switch fabric 12 onto the transmission network 3.

The switch fabric 12 performs the routing of frames between the client signal LIU 10 and the transmission network side LIU 11. The switch fabric 12 may further includes the function of detecting an alarm signal that the transmission apparatus 4b at the opposite end transmitted to the transmission apparatus 4a. The alarm signal may be a signal for indicating the occurrence of a failure in signal input from the transmission apparatus 4a to the transmission apparatus 4b.

Such an alarm signal may be, for example, an AIS (Alarm Indication Signal) or a UNEQ (unequipment) signal. The detection of the alarm signal may alternatively be performed by the transmission network side LIU 11. The control unit 13 controls the entire operation of the transmission apparatus 4a.

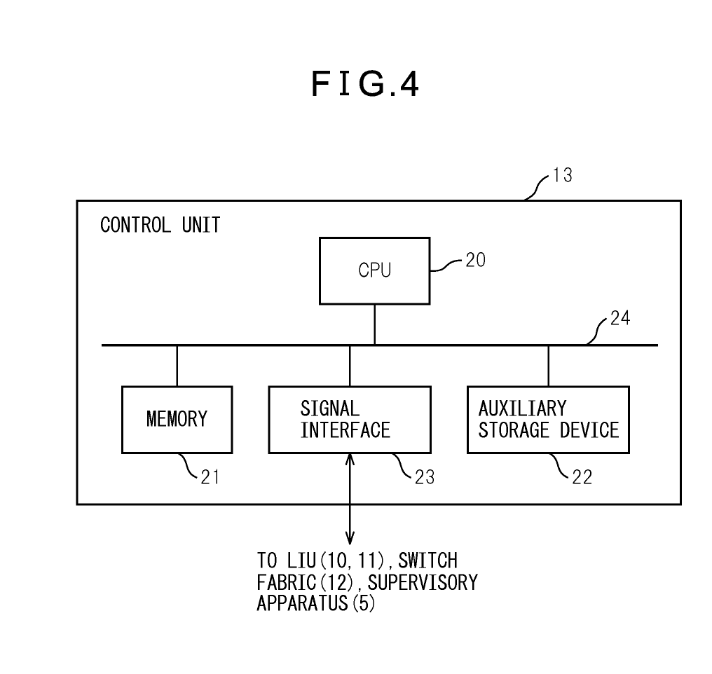

FIG. 4 is a diagram illustrating an example of the hardware configuration of the control unit 13. The control unit 13 includes a CPU 20, a memory 21, an auxiliary storage device 22, and a signal interface 23. The CPU 20, the memory 21, the auxiliary storage device 22, and the signal interface 23 are interconnected by a bus 24 via which data are transferred.

The auxiliary storage device 22 stores various kinds of computer programs and data for controlling the operation of the transmission apparatus 4a. The auxiliary storage device 22 may include a hard disk or a nonvolatile memory or the like. The CPU 20 is a data processing unit which executes the programs stored on the auxiliary storage device 22 and performs various processes for controlling the operation of the transmission apparatus 4a.

The memory 21 stores the program currently executed by the CPU 20 and the data temporarily used by the program. The signal interface 23 is an interface for signal transfers between the supervisory apparatus 5 and the control unit 13, between the client signal LIU 10 and the control unit 13, between the transmission network side LIU 11 and the control unit 13, and between the switch fabric 12 and the control unit 13.

The hardware configuration illustrated in FIG. 4 is only one example of the hardware configuration of the control unit 13. Various other hardware configurations can be employed, as long as the hardware is configured to implement the processes described hereinafter.

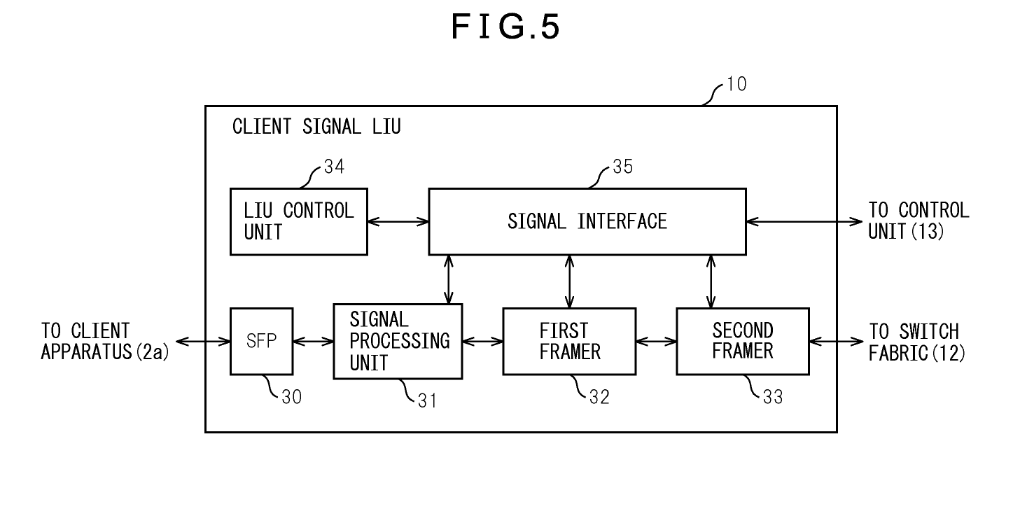

FIG. 5 is a diagram illustrating an example of the hardware configuration of the client signal LIU 10. The client signal LIU 10 includes an SPF (Small Form factor Pluggable) 30, a signal processing unit 31, a first framer 32, a second framer 33, a LIU control unit 34, and a signal interface 35.

The SFP 30 performs processing for transmission and reception of client signals at the physical layer. The signal processing unit 31 reproduces the frame of the client signal received via the SFP 30. A first-format frame that the signal processing unit 31 reproduces may be, for example, an Ethernet (registered trademark) frame. Further, the signal processing unit 31 converts a frame of the first format, output from the first framer 32, into a signal to be supplied to the SFP 30.

The first framer 32 encapsulates data of the first-format frame into a frame of a second format to be transmitted over the transmission network 3. The second-format frame may be, for example, a GFP (Generic Framing Procedure) frame. Further, the first framer 32 performs decapsulation to recover the first-format frame from the second-format frame output from the second framer 33.

The second framer 33 maps the second-format frame into a frame of a third format. The third-format frame is a frame used to transmit data between the client signal LIU 10 and the switch fabric 12 or between the transmission network side LIU 11 and the switch fabric 12. The third-format frame may be, for example, a SONET/SDH frame.

The LIU control unit 34 controls the operation of the client signal LIU 10. The LIU control unit 34 may include a CPU and a memory. The memory stores a program to be executed by the CPU and data used for the operation of the program.

The signal interface is an interface for signal transfers between the LIU control unit 34 and the control unit 13, signal processing unit 31, first framer 32, and second framer 33.

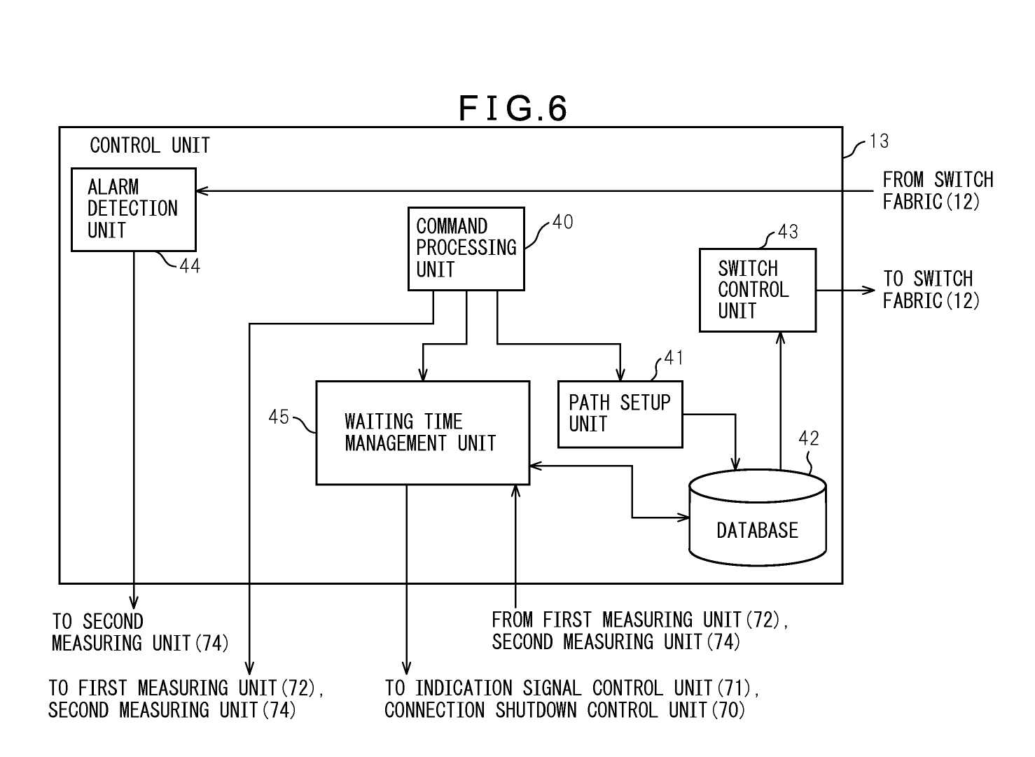

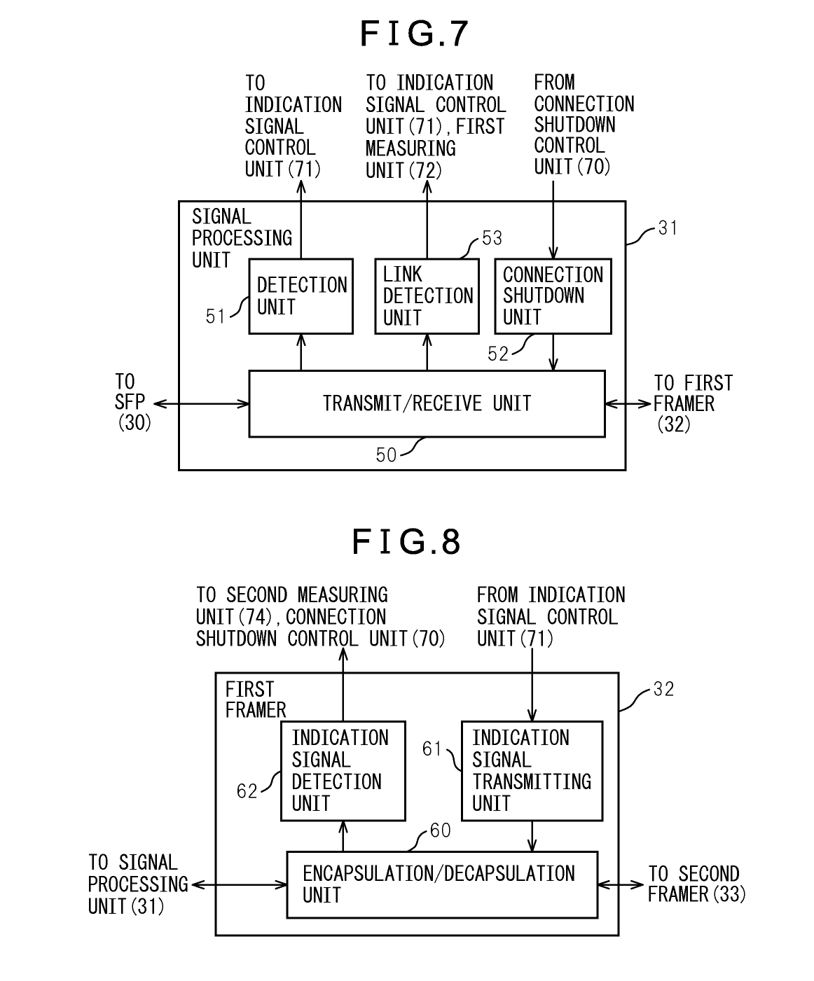

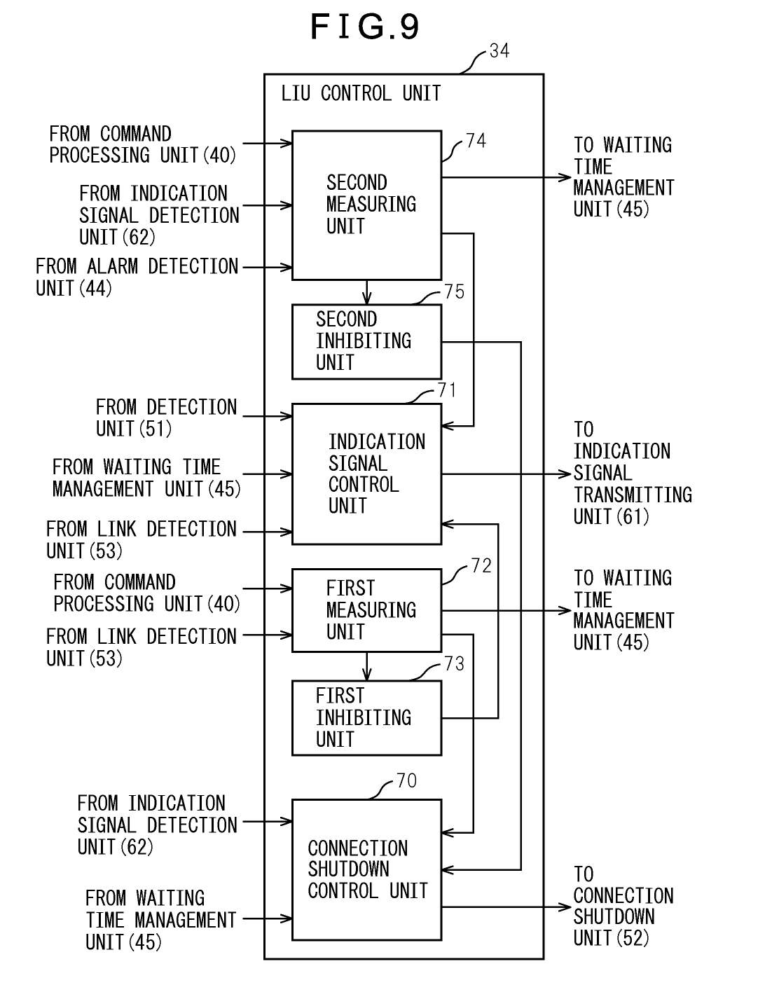

FIG. 6 is a diagram illustrating a configuration example of the control unit 13 depicted in FIG. 4. FIG. 7, FIG. 8, and FIG. 9 are diagrams illustrating configuration examples of the signal processing unit 31, the first framer 32, and the LIU control unit 34, respectively.

Reference is made to FIG. 6. The control unit 13 includes a command processing unit 40, a path setup unit 41, a database 42, a switch control unit 43, an alarm detection unit 44, and a waiting time management unit 45. The processes performed by the command processing unit 40, the path setup unit 41, the switch control unit 43, the alarm detection unit 44, and the waiting time management unit 45, respectively, are implemented by the CPU 20 executing the programs stored on the auxiliary storage unit 22 depicted in FIG. 4. In FIG. 6, the configuration of the control unit 13 is illustrated by focusing on the functions relevant to the description of the present embodiment.

Reference is made to FIG. 7. The signal processing unit 31 includes a transmit/receive unit 50, a detection unit 51, a link detection unit 53, and a connection shutdown unit 52. The transmit/receive unit 50, the detection unit 51, the link detection unit 53, and the connection shutdown unit 52 may be a transmitter/receiver, a detector, a link detector, and a connection shutdown circuit, respectively.

Reference is made to FIG. 8. The first framer 32 includes an encapsulation/decapsulation unit 60, an indication signal transmitting unit 61, and an indication signal detection unit 62. The encapsulation/decapsulation unit 60, the indication signal transmitting unit 61, and the indication signal detection unit 62 may be an encapsulator/decapsulator, an indication signal transmitter, and an indication signal detector, respectively.

Reference is made to FIG. 9. The LIU control unit 34 includes a connection shutdown control unit 70, an indication signal control unit 71, a first measuring unit 72, a first inhibiting unit 73, a second measuring unit 74, and a second inhibiting unit 75. The connection shutdown control unit 70, the indication signal control unit 71, the first measuring unit 72, the first inhibiting unit 73, the second measuring unit 74, and the second inhibiting unit 75 are a connection shutdown controller, an indication signal controller, a first measuring circuit, a first inhibiting circuit 73, a second measuring circuit, and a second inhibiting circuit, respectively.

Reference is again made to FIG. 6. The command processing unit 40 accepts a command input from the supervisory apparatus 5. The command that the command processing unit 40 accepts includes a first waiting time measuring command for directing the transmission apparatus 4a to measure a time interval suitable for use as a first waiting time.

The command that the command processing unit 40 accepts further includes a second waiting time measuring command for directing the transmission apparatus 4a to measure a time interval suitable for use as a second waiting time. The command may be one for simultaneously directing the measurement of the time interval suitable as the first waiting time and the measurement of the time interval suitable as the second waiting time.

The first waiting time is the waiting time that elapses from the moment that the LoS of the client signal is detected by the transmission apparatus 4a until the transmission apparatus 4a initiates to transmit an indication signal. That is, after the detection of the LoS of the client signal, if the detection of the LoS has continued up to the end of the first waiting time, the transmission apparatus 4a transmits out the indication signal.

The indication signal is a signal for indicating the occurrence of LoS to the transmission apparatus 4b at the far end, i.e., the opposite end, of the path over which the client signal whose LoS has been detected was to be transmitted. The indication signal may be, for example, a CSF. Upon receiving the indication signal, the transmission apparatus 4b at the opposite end shuts down the connection with the destination client apparatus 2b of the client signal.

The second waiting time is the waiting time that elapses from the moment that an indication signal inserted in a given path is received by the transmission apparatus 4a until the transmission apparatus 4a shuts down the connection with the client apparatus 2a that was to receive the client signal transmitted over that path. That is, the transmission apparatus 4a shuts down the connection with the client apparatus 2a if the reception of the indication signal has continued up to the end of the second waiting time.

The first and second waiting time measuring commands each include information for specifying the path to be measured. Each of these commands may further includes information for specifying the waiting time used as the time out for the measurement to be made or information for specifying the number of repetitions when the measurement is to be made repetitively. The command processing unit 40 causes the first measuring unit 72 to measure the time interval suitable for use as the first waiting time. Further, the command processing unit 40 causes the second measuring unit 74 to measure the time interval suitable for use as the second waiting time.

The path setup unit 41 writes to the database 42 setup information for the switch fabric 12 to set up the path specified by the first or second waiting time measuring command. By setting the switch fabric 12 in accordance with the setup information written to the database 42, the switch control unit 43 generates a cross connect for setting up the path.

Further, the path setup unit 41 generates a message for instructing the transmission apparatus 4b at the opposite end of the path specified by the command and each intermediate transmission apparatus along the path to set up the path, and sends the message to them.

The alarm detection unit 44 detects that an alarm signal has been detected by the switch fabric 12 or the transmission network side LIU 11. The alarm detection unit 44 notifies the second measuring unit 74 of the detection of the alarm signal.

The waiting time management unit 45 stores the first waiting time and the second waiting time determined by the first measuring unit 72 and the second measuring unit 74, respectively, into the database. Further, the waiting time management unit 45 notifies the indication signal control unit 71 of the first waiting time when the indication signal control unit 1 performs control to transmit the indication signal. The waiting time management unit 45 notifies the connection shutdown control unit 70 of the second waiting time when the connection shutdown control unit 70 perform shutdown control to shut down the connection with the client apparatus 2a.

Reference is next made to FIG. 7. The transmit/receive unit 50 reproduces the first-format frame from the client signal received via the SFP 30, and passes it to the first framer 32. The transmit/receive unit 50 converts the signal received from the first framer 32 into a format for input to the SFP 30, and passes it to the SFP 30.

The detection unit 51 detects a failure in reception of the client signal from the client apparatus 2a, i.e., the LoS of the client signal. The detection unit 51 notifies the indication signal control unit 71 of the occurrence of the LoS and the result of detection of restoration.

The link detection unit 53 detects link-up/link-down on the connection with the client apparatus 2a, i.e., the presence or absence of the connection with the client apparatus 2a. The link detection unit 53 sends the result of the detection to the indication signal control unit 71 and the first measuring unit 72. The connection shutdown unit 52 performs processing to shut down the connection with the client apparatus 2a or clear the connection shutdown in accordance with the instruction from the connection shutdown control unit 70.

Reference is next made to FIG. 8. The encapsulation/decapsulation unit 60 encapsulates the data of the first-format frame received from the transmit/receive unit 50 into the second-format frame to be transmitted over the transmission network 3. Further, the encapsulation/decapsulation unit 60 performs decapsulation to recover the first-format frame from the second-format frame.

The indication signal transmitting unit 61 inserts the indication signal into the specified path by inserting, in accordance with the instruction from the indication signal control unit 71, the indication signal into the second-format frame to be transmitted over the specified path. The indication signal detection unit 62 detects the indication signal from the second-format frame received from the second framer 33. The indication signal detection unit 62 notifies the connection shutdown control unit 70 and the second measuring unit 74 of the detection of the indication signal.

Reference is next made to FIG. 9. When the indication signal detection unit 62 has detected the indication signal on a given path, the connection shutdown control unit 70 instructs the connection shutdown unit 52 to shut down the connection with the client apparatus 2a to which the client signal was to be transmitted along that path. The connection shutdown control unit 70 receives information specifying the second waiting time from the waiting time management unit 45.

When the indication signal has continued up to the end of the second waiting time, the connection shutdown control unit 70 instructs the connection shutdown unit 52 to shut down the connection. That is, the connection shutdown control unit 70 holds off instructing the connection shutdown unit 52 until the indication signal is detected continuously over the second waiting time.

When the detection of the indication signal stops, the connection shutdown control unit 70 clears the shutdown condition of the connection with the client apparatus 2a. That is, the client apparatus 2a is re-connected. Further, during the time measurement by the first measuring unit 72, the connection shutdown control unit 70 performs the shutdown/re-connection control in accordance with the instruction from the first measuring unit 72.

When the notification that the detection unit 51 has detected the LoS of the client signal is received, the indication signal control unit 71 checks whether the indication signal is inserted in the path used for receiving the client signal from the destination client apparatus 2a of the client signal whose LoS has been detected. If the indication signal is not inserted, the indication signal control unit 71 instructs the indication signal transmitting unit 61 to insert the indication signal into the path over which the client signal was to be transmitted to the client apparatus 2a.

If the indication signal is inserted, since the detected LoS is the LoS that occurred due to the shutdown effected by the transmission apparatus itself, the indication signal control unit 71 does not issue the indication signal transmit instruction.

The indication signal control unit 71 receives information specifying the first waiting time from the waiting time management unit 45. When the detection of the LoS has continued up to the end of the first waiting time, the indication signal control unit 71 instructs the indication signal transmitting unit 61 to transmit the indication signal. That is, the indication signal control unit 71 performs control not to transmit the indication signal unless the LoS is detected continuously over the first waiting time.

When the link detection unit 53 has detected a link-up on the connection with the client apparatus 2a, the indication signal control unit 71 instructs the indication signal transmitting unit 61 to stop transmitting the indication signal. Further, during the time measurement by the second measuring unit 74, the indication signal control unit 71 performs the indication signal transmit/stop control in accordance with the instruction from the second measuring unit 74.

When the first waiting time measuring command is received from the command processing unit 40, the first measuring unit 72 instructs the connection shutdown control unit 70 to shut down the connection with the client apparatus 2a to which the client signal was to be transmitted over the path specified by the command. When the link detection unit 53 has detected a link-down on the connection with the client apparatus 2a, the first measuring unit 72 instructs the connection shutdown control unit 70 to clear the shutdown. At the same time that the shutdown is cleared, the first measuring unit 72 starts measuring the time by a timer.

The first measuring unit 72 checks whether the link detection unit 53 detects a link-up on the connection with the client apparatus 2a within a given waiting time. The waiting time may be specified by the first waiting time measuring command or by some other means or may be a fixed value.

If a link-up is detected within the waiting time, the first measuring unit 72 determines the time interval between the clearing of the shutdown condition and the detection of the link-up condition as the first waiting time. The first measuring unit 72 notifies the waiting time management unit 45 of the first waiting time. The waiting time management unit 45 stores the first waiting time in the database 42. In this case, the command processing unit 40 sends a positive response to the supervisory apparatus 5. If a link-up has not been detected within the waiting time, the command processing unit 40 sends a negative response to the supervisory apparatus 5.

The first measuring unit 72 may repeat the measurement a plurality of times. The first measuring unit 72 may determine the first waiting time by selecting one of the maximum value, average value, and minimum value, excluding singular points, from among the results of the plurality of measurements.

The reason for determining the first waiting time as described above will be given below. The transmission apparatus 4a that shut down the connection with the client apparatus 2a in response to the indication signal clears the shutdown upon detecting the stopping of reception of the indication signal. The LoS continues to be detected after the shutdown is cleared, until the link-up is detected. If an indication signal is sent out in response to this LoS, shutdown control will also be performed at the transmission apparatus 4b at the opposite end. Then, at this transmission apparatus 4b also, there can occur cases where the indication signal is again sent out when the shutdown is cleared, which causes network disturbances.

According to the present embodiment, such network disturbances are prevented by providing the first waiting time so that, even if LoS is detected, the transmission of the indication signal is not initiated until a given period of time elapses after the reception of the indication signal has stopped.

However, the length of the time interval suitable for use as the first waiting time differs depending on such factors as the client apparatus 2 and the transmission path. Furthermore, many client apparatuses are connected to each transmission apparatus 4. Therefore, if the network designer were to determine an optimum time interval and manually select the first waiting time for each client apparatus 2, it would take a lot of time and be very costly.

The first waiting time determined according to the present embodiment indicates the time interval that elapses from the moment that the connection with the affected client apparatus 2 is shut down until the LoS becomes no longer detected as a result of the link-up. The time interval determined according to the present embodiment is therefore the shortest possible time interval that can be specified as the first waiting time.

Accordingly, by determining the first waiting time based on the time interval measured as in the present embodiment, the first waiting time is optimized. This further serves to greatly reduce the labor of the network designer when setting the first waiting time.

The first inhibiting unit 73 inhibits the indication signal control unit 71 from instructing the indication signal transmitting unit 61 to send out the indication signal during the measurement by the first measuring unit 72 even if LoS is detected. The first inhibiting unit 73 thus acts to prevent the transmission of an unwanted indication signal by the first waiting time measuring command.

Next, the measuring process performed by the second measuring unit 74 will be described. When the second waiting time measuring command is received from the command processing unit 40, the second measuring unit 74 instructs the indication signal control unit 71 to transmit the indication signal over the path specified by the command. After that, the second measuring unit 74 determines whether one of two conditions is satisfied, i.e., whether an alarm signal has been received from the destination transmission apparatus 4b of the indication signal or whether a given waiting time has elapsed. The waiting time may be specified by the second waiting time measuring command or by some other means or may be a fixed value.

If the reception of an alarm signal is not detected, and if a failure is detected before the waiting time elapses, the second measuring unit 74 stops the measuring process. Then, the command processing unit 40 sends a negative response to the supervisory apparatus 5.

If the reception of an alarm signal is detected, or if the waiting time has elapsed, the second measuring unit 74 instructs the indication signal control unit 71 to stop transmitting the indication signal. At the same time that the transmission of the indication signal is stopped, the second measuring unit 74 starts measuring the time by a timer.

When the indication signal is received, the transmission apparatus 4b at the opposite end shuts down the connection with the client apparatus 2b that was to receive the client signal over the path on which the indication signal has been detected. When the reception of the indication signal stops, the transmission apparatus 4b at the opposite end clears the shutdown condition of the connection with the client apparatus 2b. The transmission apparatus 4b continues to detect LoS until the link-up of the connection with the client apparatus 2b is completed. As a result, the transmission apparatus 4b inserts an indication signal into the path over which the client signal originating from the client apparatus 2b is transmitted.

The second measuring unit 74 checks whether the indication signal detection unit 62 has detected an indication signal on the path specified by the command as the path over which the client signal from the client apparatus 2b is to be transmitted. If an indication signal is not detected, the second measuring unit 74 stops the measuring process. Then, the command processing unit 40 sends a negative response to the supervisory apparatus 5. If an indication signal is detected by the indication signal detection unit 62, the second measuring unit 74 waits until the detection of the indication signal stops.

When the detection of the indication signal stopped, the second measuring unit 74 determines the time interval that elapsed from the time that the transmission of the indication signal by the indication signal control unit 71 stopped until the time that the detection of the indication signal by the indication signal detection unit 62 stopped as the second waiting time. The second measuring unit 74 notifies the waiting time management unit 45 of the second waiting time. The waiting time management unit 45 stores the second waiting time in the database 42. In this case, the command processing unit 40 sends a positive response to the supervisory apparatus 5.

The second measuring unit 74 may repeat the measurement a plurality of times. The second measuring unit 74 may determine the second waiting time by selecting one of the maximum value, average value, and minimum value, excluding singular points, from among the results of the plurality of measurements.

The reason for determining the second waiting time as described above will be given below. As described earlier, after the transmission apparatus 4a has stopped transmitting the indication signal, the transmission apparatus 4b at the opposite end may send out an indication signal during the time interval between the stopping of reception of the indication signal and the completion of the link-up of the connection with the client apparatus 2b. Accordingly, by providing the second waiting time during which the transmission apparatus 4b does not perform the shutdown control even if the indication signal to be received is received during that time interval, network disturbances are prevented.

The length of the time interval suitable for use as the second waiting time differs depending on such factors as the client apparatus 2b connected to the transmission apparatus 4b at the opposite end and the transmission path. Furthermore, many client apparatuses 2b are connected to each transmission apparatus 4b. Therefore, if the network designer were to determine an optimum time interval and manually select the second waiting time for each client apparatus 2, it would take a lot of time and be very costly.

As a result, in the prior art apparatus, an excessively large fixed value is often set as the second waiting time. If the second waiting time is too long, a delay occurs in the recovery process such as shutdown in the event of a failure, leading to the problem that the amount of data loss increases. A delay also occurs in the restoration process at the time of failure restoration.

The second waiting time determined according to the present embodiment indicates the time interval that elapses from the moment that the transmission apparatus 4a stops transmitting the indication signal until the transmission apparatus 4b at the opposite end stops transmitting the indication signal. The time interval determined according to the present embodiment is therefore the shortest possible time interval that can be specified as the second waiting time. Accordingly, by determining the second waiting time based on the time interval measured as in the present embodiment, the second waiting time is optimized, and the amount of data loss that occurs in the event of a failure is reduced. This further serves to greatly reduce the labor of the network designer when setting the second waiting time.

The second inhibiting unit 75 inhibits the connection shutdown control unit 70 from instructing the connection shutdown unit 52 to shut down the connection during the measurement by the second measuring unit 74 even if the indication signal is detected on the path being measured. The second inhibiting unit 75 thus acts to prevent unwanted shutdown control by the second waiting time measuring command.

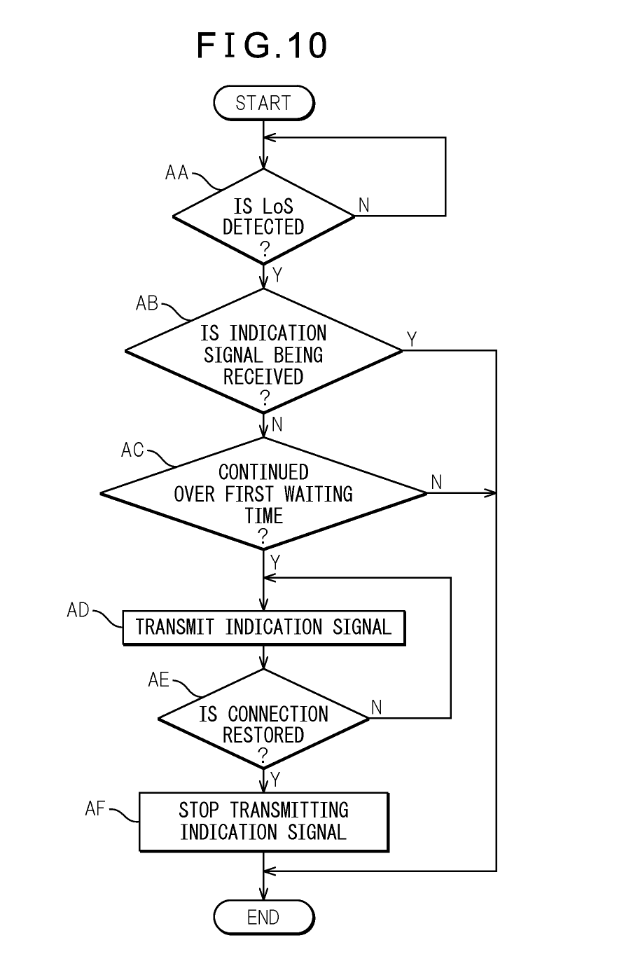

Next, the processes performed by the transmission apparatus 4 according to the present embodiment will be described. FIG. 10 is a diagram illustrating the indication signal transmitting process performed when LoS is detected. In an alternative embodiment, the following operations AA to AF may be implemented as steps. In operation AA, the detection unit 51 tries to detect LoS. If LoS is detected (Y in operation AA), the process proceeds to operation AB. If LoS is not detected (N in operation AA), operation AA is repeated.

In operation AB, the indication signal control unit 71 checks to see if an indication signal is detected on the path over which a client signal was to be received from the client apparatus from which the LoS has been detected. If an indication signal is detected (Y in operation AB), the process is terminated without sending out an indication signal. If an indication signal is not detected (N in operation AB), the process proceeds to operation AC.

In operation AC, the indication signal control unit 71 checks to see if the LoS is detected continuously over the first waiting time. If the LoS is detected continuously over the first waiting time (Y in operation AC), the process proceeds to operation AD. If the LoS is not detected continuously over the first waiting time (N in operation AC), the process is terminated without sending out an indication signal.

In operation AD, the indication signal control unit 71 instructs the indication signal transmitting unit 61 to transmit the indication signal onto the path over which a client signal was to be transmitted to the client apparatus 2 from which the LoS has been detected.

In operation AE, the link detection unit 53 determines whether the connection with the client apparatus 2 has been restored, that is, whether a link-up is detected. If the connection with the client apparatus 2 has been restored (Y in operation AE), the process proceeds to operation AF. If the connection with the client apparatus 2 has not been restored yet (N in operation AE), the process returns to operation AD.

In operation AF, the indication signal control unit 71 instructs the indication signal transmitting unit 61 to stop transmitting the indication signal.

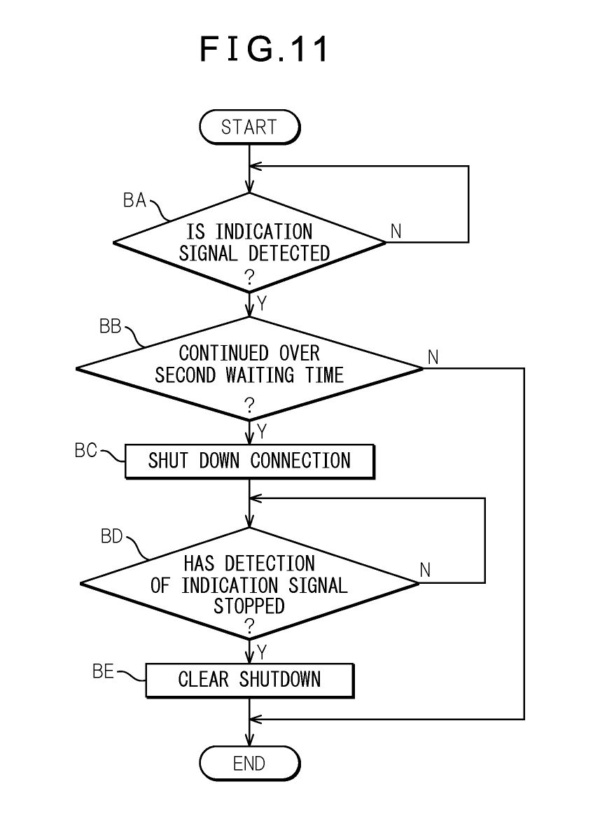

FIG. 11 is a diagram illustrating the connection shutdown process performed when an indication signal is received. In an alternative embodiment, the following operations BA to BE may be implemented as steps. In operation BA, the indication signal detection unit 62 tries to detect an indication signal from the second-format frame received from the second framer 33. If an indication signal is detected (Y in operation BA), the process proceeds to operation BB. If an indication signal is not detected (N in operation BA), operation BA is repeated.

In operation BB, the connection shutdown control unit 70 checks to see if the indication signal is detected continuously over the second waiting time. If the indication signal is detected continuously over the second waiting time (Y in operation BB), the process proceeds to operation BC. If the indication signal is not detected continuously over the second waiting time (N in operation BB), the process is terminated without shutting down the connection with the client apparatus 2.

In operation BC, the connection shutdown control unit 70 instructs the connection shutdown unit 52 to shut down the connection with the client apparatus 2 to which the client signal was to be transmitted via the path on which the indication signal has been detected.

In operation BD, the indication signal detection unit 62 determines whether the detection of the indication signal has stopped. If the detection of the indication signal has stopped (Y in operation BD), the process proceeds to operation BE. If the detection of the indication signal has not stopped yet (N in operation BD), operation BD is repeated.

In operation BE, the connection shutdown control unit 70 clears the shutdown condition of the connection with the client apparatus 2.

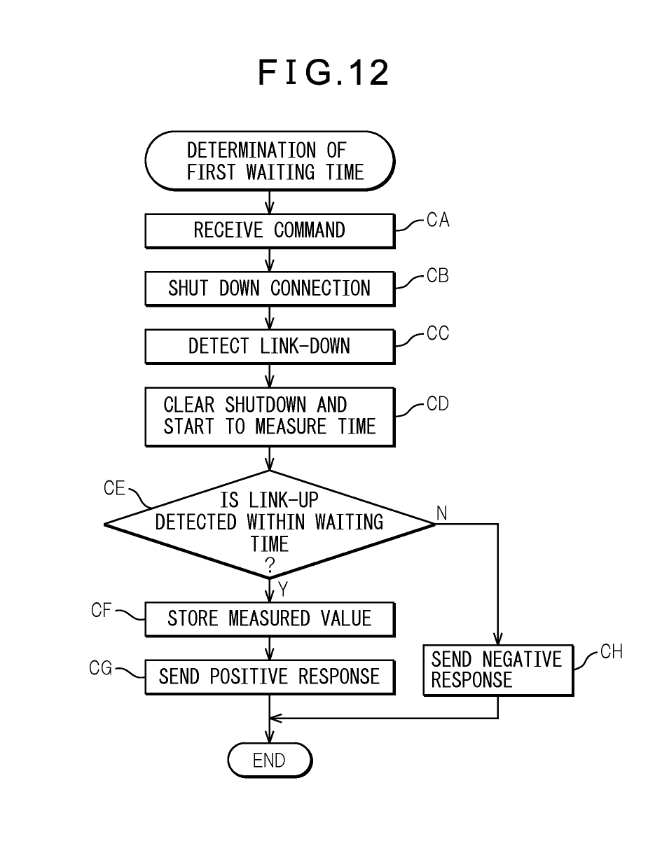

Next, the processes for determining the first waiting time and the second waiting time, respectively, will be described. FIG. 12 is a diagram illustrating the process for determining the first waiting time. In an alternative embodiment, the following operations CA to CH may be implemented as steps. In operation CA, the first measuring unit 72 receives the first waiting time measuring command from the command processing unit 40.

In operation CB, the first measuring unit 72 instructs the connection shutdown control unit 70 to shut down the connection with the client apparatus 2 to which the client signal was to be transmitted over the path specified by the command. In operation CC, the link detection unit 53 detects a link-down on the connection with the client apparatus 2.

In operation CD, the first measuring unit 72 instructs the connection shutdown control unit 70 to clear the shutdown. At the same time that the shutdown is cleared, the first measuring unit 72 starts measuring the time by a timer. Further, the first inhibiting unit 73 inhibits the indication signal control unit 71 from instructing the indication signal transmitting unit 61 to transmit out the indication signal, even if LoS is detected, until the first waiting time determining process by the first measuring unit 72 is completed.

In operation CE, the first measuring unit 72 determines whether the link detection unit 53 detects a link-up on the connection with the client apparatus 2 within a given waiting time. If a link-up is detected (Y in operation CE), the process proceeds to operation CF. If a link-up is not detected (N in operation CE), the process proceeds to operation CH.

In operation CF, the first measuring unit 72 determines the time interval between the clearing of the shutdown condition and the detection of the link-up condition as the first waiting time. The first measuring unit 72 notifies the waiting time management unit 45 of the first waiting time. The waiting time management unit 45 stores the first waiting time in the database 42.

In operation CG, the command processing unit 40 sends a positive response to the supervisory apparatus 5. On the other hand, in operation CH, the command processing unit 40 sends a negative response to the supervisory apparatus 5.

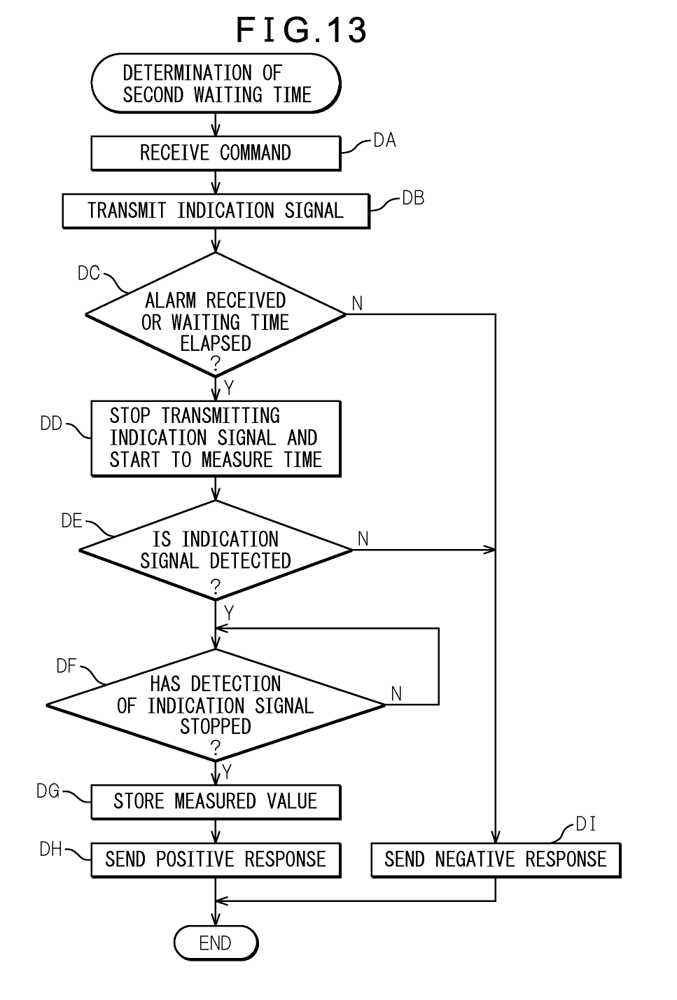

FIG. 13 is a diagram illustrating the process for determining the second waiting time. In an alternative embodiment, the following operations DA to DI may be implemented as steps. In operation DA, the second measuring unit 74 receives the second waiting time measuring command from the command processing unit 40.

In operation DB, the second measuring unit 74 instructs the indication signal control unit 71 to transmit the indication signal over the path specified by the command. In operation DC, the second measuring unit 74 determines whether one of two conditions is satisfied, that is, whether an alarm signal has been received from the destination transmission apparatus 4 of the indication signal or whether a given waiting time has elapsed. If one of the two conditions is satisfied (Y in operation DC), the process proceeds to operation DD. If the reception of an alarm signal is not detected, and if a failure is detected before the waiting time elapses (N in operation DC), the process proceeds to operation DI.

In operation DD, the second measuring unit 74 instructs the indication signal control unit 71 to stop transmitting the indication signal. At the same time that the transmission of the indication signal is stopped, the second measuring unit 74 starts measuring the time by a timer.

In operation DE, the indication signal detection unit 62 tries to detect the indication signal on the path specified by the command. If the indication signal is detected (Y in operation DE), the process proceeds to operation DF. If the indication signal is not detected (N in operation DE), the process proceeds to operation DI.

In operation DF, the second measuring unit 74 determines whether the detection of the indication signal by the indication signal detection unit 62 has stopped. If the detection of the indication signal has stopped (Y in operation DF), the process proceeds to operation DG. If the detection of the indication signal has not stopped yet (N in operation DF), operation DF is repeated. As long as the indication signal is detected, the second inhibiting unit 75 inhibits the connection shutdown control unit 70 from instructing the connection shutdown unit 52 to shut down the connection.

In operation DG, the second measuring unit 74 determines the time interval that elapsed from the time that the transmission of the indication signal by the indication signal control unit 71 stopped until the time that the detection of the indication signal by the indication signal detection unit 62 stopped as the second waiting time. The second measuring unit 74 notifies the waiting time management unit 45 of the second waiting time. The waiting time management unit 45 stores the second waiting time in the database 42.

In operation DH, the command processing unit 40 sends a positive response to the supervisory apparatus 5. On the other hand, in operation DI, the command processing unit 40 sends a negative response to the supervisory apparatus 5.

According to the present embodiment, when the indication signal is received, the transmission apparatus 4 holds off transmitting out the indication signal during the period of the first waiting time, even if LoS is detected when clearing the shutdown condition of the connection with the client apparatus 2 by a failure recovery. This prevents unwanted indication signal transmissions, and network disturbances can thus be prevented.

According to the present embodiment, it becomes possible to optimize the first waiting time and the second waiting time by the series of processes that the client signal LIU 10 performs. Since these waiting times can be optimized in practice, delays in fault recovery and restoration operations can be reduced. As a result, the amount of data loss that occurs in the event of a failure can be reduced.

According to the transmission apparatus 4a of the present embodiment, even if the transmission apparatus 4b at the opposite end that is receiving the indication signal from the transmission apparatus 4a transmits out an indication signal when clearing the shutdown condition after the reception of the indication signal has stopped, the transmission apparatus 4a prevents the shutdown control from being initiated in response to such an indication signal. Accordingly, the transmission apparatus 4a can prevent network disturbances even if the transmission apparatus 4b at the opposite end is not equipped with the functions implemented by the present embodiment.

Likewise, according to the transmission apparatus 4a of the present embodiment, when the connection with the client apparatus 2a is shut down in response to the reception of the indication signal, the transmission apparatus 4a prevents an indication signal from being transmitted out when clearing the shutdown condition by a failure recovery. Accordingly, the transmission apparatus 4a can prevent network disturbances even if the transmission apparatus 4b at the opposite end is not equipped with the functions implemented by the present embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A communication interface apparatus comprising:
a transmitter/receiver which transmits and receives a client signal to and from a client apparatus;
a detector which detects a failure in reception of the client signal;
an indication signal transmitter which transmits, to a transmission apparatus at a far end of a path set up over a transmission network to transmit the client signal, an indication signal that causes the transmission apparatus to shut down a connection for transmitting and receiving the client signal to and from a client apparatus; and
an indication signal controller which performs control not to transmit out the indication signal unless the failure in reception of the client signal continues over a first waiting time.

2. The communication interface apparatus according to claim 1, further comprising:
a connection shutdown circuit which shuts down the connection that the transmitter/receiver uses for transmission and reception of the client signal; and
a first measuring circuit which measures a time interval between initiation of a reconnection of the connection shut down by the connection shutdown circuit and completion of the reconnection, and wherein:
the first waiting time is the time interval measured by the first measuring circuit.

3. The communication interface apparatus according to claim 2, further comprising a first inhibiting circuit which inhibits the indication signal transmitter from transmitting the indication signal during the measurement by the first measuring circuit.

4. The communication interface apparatus according to claim 2, wherein the indication signal controller uses, as the first waiting time, a maximum value taken by excluding a singular point from among results of a plurality of measurements made by the first measuring circuit.

5. The communication interface apparatus according to claim 1, further comprising an encapsulator which encapsulates the client signal into a frame of a format adapted for transmission on the transmission network, and wherein:
the indication signal transmitter inserts the indication signal into a transmission frame of the format transmitted to the transmission apparatus; and
the indication signal controller performs control so that the indication signal transmitter does not insert the indication signal unless the failure in reception of the client signal continues over the first waiting time.

6. A communication interface apparatus comprising:
a transmitter/receiver which transmits and receives a client signal to and from a client apparatus;
an indication signal transmitter which transmits, to a transmission apparatus at a far end of a path set up over a transmission network to transmit the client signal via the transmission network, an indication signal that causes the transmission apparatus to shut down a connection for transmitting and receiving the client signal to and from a client apparatus;
an indication signal detector which detects the indication signal transmitted from the transmission apparatus;
a connection shutdown circuit which shuts down the connection that the transmitter/receiver uses for transmission and reception of the client signal;
a connection shutdown controller which performs control so that the connection shutdown circuit does not shut down the connection unless the indication signal is detected continuously over a second waiting time; and
a second measuring circuit which measures a time interval that elapses from the time that the transmission of the indication signal by the indication signal transmitter is stopped until the time that the indication signal becomes no longer detected by the indication signal detector, and wherein:
the second waiting time is the time interval measured by the second measuring circuit.

7. The communication interface apparatus according to claim 6, further comprising a second inhibiting circuit which inhibits the connection shutdown circuit from shutting down the connection during the measurement by the second measuring circuit.

8. The communication interface apparatus according to claim 6, wherein the connection shutdown controller uses, as the second waiting time, a maximum value taken by excluding a singular point from among results of a plurality of measurements made by the second measuring unit.

9. The communication interface apparatus according to claim 8, further comprising:
an encapsulator which encapsulates the client signal into a frame of a format adapted for transmission on the transmission network; and
a decapsulator which decapsulates the client signal from a frame of the format, and wherein:
the indication signal transmitter inserts the indication signal into a transmission frame of the format transmitted to the transmission apparatus; and
the indication signal detector detects the indication signal from a received frame of the format received from the transmission apparatus.

10. An indication signal transmission control method comprising:
detecting a failure in reception of a client signal transmitted from a client signal; and
performing control not to transmit, to a transmission apparatus at a far end of a path set up over a transmission network to transmit the client signal, an indication signal that causes the transmission apparatus to shut down a connection for transmitting and receiving the client signal to and from a client apparatus, unless the failure in reception of the client signal continues over a first waiting time.

11. A connection shutdown control method comprising:
transmitting, to a transmission apparatus at a far end of a path set up over a transmission network to transmit a client signal via the transmission network, an indication signal that causes the transmission apparatus to shut down a connection for transmitting and receiving the client signal to and from a client apparatus;
stopping the transmission of the indication signal;
determining a second waiting time by measuring a time interval that elapses from the time that the transmission of the indication signal is stopped until the time that the transmission of the indication signal by the transmission apparatus stops; and
using the second waiting time as a waiting time between the time that the indication signal is received from the transmission apparatus and the time that a connection for transmitting and receiving the client signal to and from a client apparatus is shut down.
